(19) United States
(12) Patent Application Publication
(10) Pub. No.: US 2004/0090375 A1
(43) Pub. Date: May 13, 2004

(54) Wide-band antenna

(76) Inventors: Hsin Kuo Dai, Tu-chen (TW); Hsiang-Hui Shen, Tu-chen (TW); Kun Te Cheng, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/325,005

(22) Filed: Dec. 19, 2002

(30) Foreign Application Priority Data
Nov. 13, 2002 (TW) 91218163

(51) Int. Cl. H01Q 1/38; H01Q 1/24

(52) U.S. Cl. 343/700 MS; 343/702

(57) ABSTRACT

A wide-band antenna (1) for a wireless communication device has a ground plane (14), a first radiating portion (11), a second radiating portion (12), and a third radiating portion (13). The first and second radiating portions both extend from a same edge of the ground plane and together constitute a first frequency resonant structure. The third radiating portion extends from a proximal end of the second radiating portion. The second and third radiating portions together constitute a second frequency resonant structure.

### BACKGROUND OF THE INVENTION

1. Field of the Invention

The present invention relates in general to antenna structures, and in particular to a wide-band antenna structure in a wireless communication device.

2. Description of the Prior Art

There is a growing need for micro-strip patch antennas for use in wireless communication devices to receive and transmit RF signals. However, patch antennas have a major disadvantage: narrow bandwidth.

FIG. 1 shows a conventional antenna 3 comprising a ground element 33 and a first and second radiating elements 31, 32. The first and second radiating elements 31, 32 together constitute a frequency resonant structure. FIG. 2 shows a computer simulated return loss chart for the antenna 3. A value of the return loss below the threshold value “−10 dB” between point C and point D shown in the FIG. 2 indicates acceptably efficient operation bandwidth. This bandwidth of acceptably efficient operation of the antenna 3 lies between point C, corresponding to 2.32 GHz, and point D, corresponding to 2.56 GHz. Thus, the bandwidth of the antenna 3 is only 0.24 GHz.

However, the conventional antenna only has one resonating frequency so that the operating bandwidth of the antenna is narrow.

Hence, an improved antenna with a wider bandwidth is desired to overcome the above-mentioned shortcoming of the existing antenna.

### BRIEF SUMMARY OF THE INVENTION

A primary object of the present invention is to provide an antenna with two resonating frequencies, which yield a wider operating bandwidth.

A wide-band antenna in accordance with the present invention for a wireless communication device comprises a ground plane, a first radiating portion, a second radiating portion, and a third radiating portion. The first and second radiating portions both extend from a first edge of the ground plane. The third radiating portion bends from a second edge of the second radiating portion. The first radiating portion has a first radiating patch and a first connecting patch connecting an end of the first radiating patch with the first edge of the ground plane. The second radiating portion has a second radiating patch and a second connecting patch connecting an end of the second radiating patch with the first edge of the ground plane. The third radiating portion has a third radiating patch and a third connecting patch connecting the second radiating patch with an end of the third radiating patch. A coaxial cable feeder has a conductive inner core and a conductive outer shield. The inner core is connected to the second radiating patch and the outer shield is connected to the first connecting patch. The first radiating patch, the second radiating patch, and a first aperture defined therebetween constitute a first frequency resonant structure. The second radiating patch, the third radiating patch, and a second aperture defined therebetween constitute a second frequency resonant structure.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a conventional antenna;

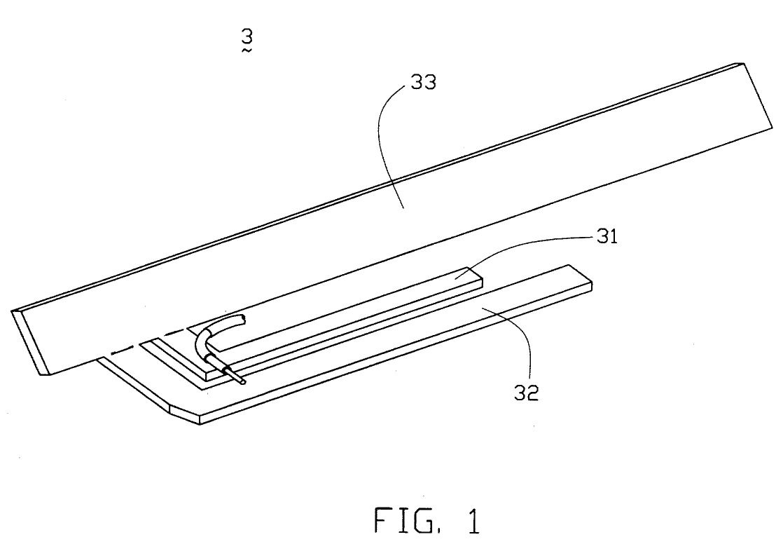

FIG. 2 is a computer simulated return loss chart for the conventional antenna of FIG. 1.

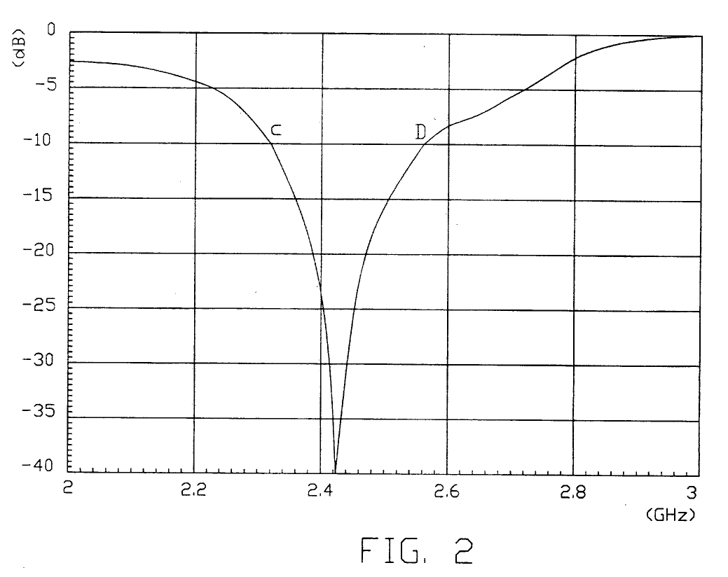

FIG. 3 is a perspective view of a preferred embodiment of a wide-band antenna in accordance with the present invention;

FIG. 4 computer simulated return loss chart for the wide-band antenna of FIG. 3.

### DETAILED DESCRIPTION OF THE INVENTION

Reference will now be made in detail to a preferred embodiment of the present invention.

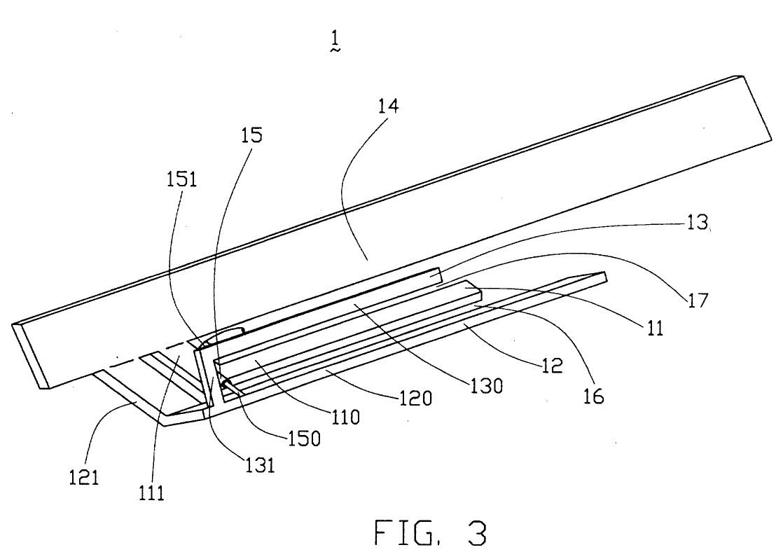

Referring to FIG. 3, a wide-band antenna 1 in accordance with the present invention is integrally made from a metal sheet, and includes a first radiating portion 11, a second radiating portion 12, a third radiating portion 13, and a ground plane 14. The first, second and third radiating portions 11, 12 and 13 all have L-shaped structures. The ground plane 14 has a substantially elongated rectangular shape with a first edge (not labeled) being parallel to a longitudinal axis of the ground plane. The first and second radiating portions 11, 12 both extend from the first edge of the ground plane 14, and near one end of the ground plane 14. The second radiating portion 12 has a second edge (not labeled). The third radiating portion 13 bends from the second edge of the second radiating portion 12.

The first radiating portion 11 includes an elongated rectangular first radiating patch 110 and a first connecting patch 111 connecting an end of the first radiating patch 110 with the first edge of the ground plane 14. The first connecting patch 111 is perpendicular to the first edge of the ground plane 14 and the first radiating patch 110 is perpendicular to the first connecting patch 111. The second radiating portion 12 includes an elongated rectangular second radiating patch 120 and a second connecting patch 121 connecting an end of the second radiating patch 120 with the first edge of the ground plane 14. The second connecting patch 121 is perpendicular to the first edge of the ground plane 14 and the second radiating patch 120 is perpendicular to the second connecting patch 121. The third radiating portion 13 includes an elongated rectangular third radiating patch 130 and a third connecting patch 131 connecting an end of the third radiating patch 130 and the second radiating patch 120. The third connecting patch 131 bends upwardly from the second edge of the second radiating patch 120. The third connecting patch 131 is perpendicular to the second edge of the second radiating patch 120 and the third radiating patch 130 is perpendicular to the third connecting patch 131. Axes of the first, second and third radiating patches 110, 120 and 130 are parallel to the longitudinal axis of the ground plane 14. A first aperture 16 is defined between the first and second radiating patches 110, 120. A second aperture 17 is defined between the second and third radiating patches 120, 130.

A coaxial cable feeder 15 comprises a conductive inner core 150, an inner dielectric layer (not labeled) around the inner core 150, a conductive outer shield 151 around the inner dielectric layer, and an outer dielectric layer (not labeled) around the conductive outer shield 151. The inner core 150 is soldered onto a top surface of the second radiating patch 120 near the junction with the third connecting patch 131, and the outer shield 151 is soldered onto a top surface of the first connecting patch 111. RF signals are fed to the wide-band antenna 1 through the conductive inner core 150 of the coaxial cable 15. The location of the solder point of the inner core 150 on the second radiating patch 120 is predetermined to achieve a desired matching impedance.

The first and second radiating patches 110, 120 together constitute a first resonant structure. A first resonating frequency electric field is formed in the first aperture 16 defined between the first and second radiating patches 110, 120, radiating at a first resonating frequency. The second and third radiating patches 120, 130 together constitute a second resonant structure. A second resonating frequency electric field is formed in the second aperture 17 defined between the second radiating patch 120 and the third radiating patch 130, radiating at a second resonating frequency.

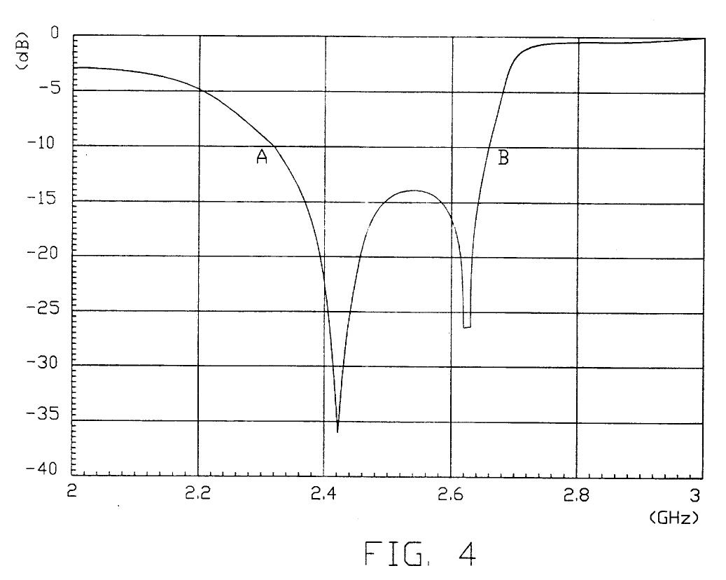

FIG. 4 shows a computer simulated return loss chart for the wide-band antenna 1. A value of the return loss below the threshold value “−10 dB” indicates acceptably efficient operation. In FIG. 4, values of return loss are below “−10 dB” for all frequencies between points A and B, which correspond to the frequencies 2.32 GHz and 2.66 GHz. Therefore, the bandwidth of acceptably efficient operation is indicated to be 2.32 GHz to 2.66 GHz, so the bandwidth is 0.34 GHz wide. This compares favorably with the 0.24 GHz bandwidth of the prior art antenna. The bandwidth is this wide because the wide-band antenna has two resonating frequencies, whose bands of acceptable return losses overlap.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wide-band antenna for a wireless communication device, comprising:
a ground plane;
a first radiating portion extending from a first edge of the ground plane;
a second radiating portion extending from the first edge of the ground plane; and
a third radiating portion extending from the second radiating portion;
wherein the first and second radiating portions together constitute a first frequency resonant structure, and the second and third radiating portions together constitute a second frequency resonant structure.

2. The wide-band antenna as claimed in claim 1, wherein the ground plane is elongate in structure and the first edge is parallel to a longitudinal axis of the ground plane;

3. The wide-band antenna as claimed in claim 2, wherein the first radiating portion includes a first radiating patch and a first connecting patch connecting an end of the first radiating patch with the first edge of the ground plane;

4. The wide-band antenna as claimed in claim 3, Wherein the second radiating portion includes a second radiating patch and a second connecting patch connecting an end of the second radiating patch with the first edge of the ground plane;

5. The wide-band antenna as claimed in claim 4, wherein the third radiating portion includes a third radiating patch and a third connecting patch connecting an end of the third radiating patch with a second edge of the second radiating portion.

6. The wide-band antenna as claimed in claim 5, wherein the first radiating patch is perpendicular to the first connecting patch, and the second radiating patch is perpendicular to the second connecting patch.

7. The wide-band antenna as claimed in claim 6, wherein the third connecting patch bends upwardly and perpendicularly from the second edge of the second radiating portion and the third radiating patch is perpendicular to the third connecting patch.

8. The wide-band antenna as claimed in claim 7, wherein a first aperture is defined between the first and second radiating patches, and a second aperture is defined between the second and third radiating patches.

9. The wide-band antenna as claimed in claim 8, wherein longitudinal axes of the first, second and third radiating patches are all parallel to the longitudinal axis of the ground plane.

10. The wide-band antenna as claimed in claim 1, wherein the first, second and third radiating portions all have L-shaped structures.

11. A wide-band antenna assembly for a wireless communication device, comprising:
a ground plane, having an elongated structure and a first edge parallel to a longitudinal axis of the ground plane;
a first radiating portion extending from the first edge of the ground plane and having a first radiating patch and a first connecting patch connecting an end of the first radiating patch with the first edge of the ground plane;
a second radiating portion extending from the first edge of the ground plane and having a second radiating patch and a second connecting patch connecting an end of the second radiating patch with the first edge of the ground plane;
a third radiating portion extending from the second radiating patch and having a third radiating patch and a third connecting patch connecting the second radiating patch and an end of the third radiating patch; and
a coaxial cable feeder comprising a conductive inner core wire, a dielectric layer and a conductive outer shield, wherein the inner core wire is connected to the second radiating patch and the outer shield is connected to the first connecting patch;
wherein a first aperture is defined between the first and second radiating patches, which constitute a first frequency resonant structure, and a second aperture is defined between the second and third radiating patches, which constitute a second frequency resonant structure.

12. The wide-band antenna assembly as claimed in claim 11, wherein the first radiating patch is perpendicular to the first connecting patch, and the second radiating patch is perpendicular to the second connecting patch.

13. The wide-band antenna assembly as claimed in claim 12, wherein the third connecting patch bends upwardly and perpendicularly from a second edge of the second radiating patch and the third radiating patch is perpendicular to the third connecting patch.

14. The wide-band antenna assembly as claimed in claim 13, wherein longitudinal axes of the first, second and third radiating patches are all parallel to the longitudinal axis of the ground plane.

15. The wide-band antenna assembly as claimed in claim 11, wherein the first, second and third radiating portions all have L-shaped structures.

16. A wide-band antenna assembly comprising:
a ground plane extending in a first direction;
a planar L-shaped first radiating portion having a short section extending from one edge of the ground plane in a second direction perpendicular to said first direction, and a long section extending from a distal end of the short section parallel to said first direction;
an L-like second radiating portion having a short segment extending from said edge of the grounding plane parallel to said second direction and spaced from the short section of the first radiating portion, and a long segment extending from a distal end of the short segment parallel to said first direction; wherein
said short segment defines a first plane, and said long segment defines a second plane angled relative to said first plane.

17. The assembly as claimed in claim 16, wherein an L-shaped third radiating portion extends from an outer edge of the long segment adjacent to said short segment, and includes a short portion perpendicularly extending from said outer edge toward the ground plane, and a long portion extending from a distal end of the short portion parallel to said first direction.

18. The assembly as claimed in claim 16, wherein said ground plane is angled relative to the short section and the short segment.

19. The assembly as claimed in claim 16, further including a cable with an inner conductor soldered on the long segment and an outer conductor soldered on the long section.
